(19) United States
(12) Patent Application Publication
(10) Pub. No.: US 2025/0067974 A1
(43) Pub. Date: Feb. 27, 2025

(54) OPTICAL DEVICE FOR PREVENTING DEW CONDENSATION

(71) Applicant: Qisda Corporation, Taoyuan City (TW)

(72) Inventors: Hung-Yen HUANG, Taoyuan City (TW); Chun-Ming SHEN, Taoyuan City (TW)

(73) Assignee: Qisda Corporation, Taoyuan City (TW)

(21) Appl. No.: 18/773,688

(22) Filed: Jul. 16, 2024

(30) Foreign Application Priority Data
Aug. 25, 2023 (CN) 202311081521.X
Aug. 25, 2023 (CN) 202322300372.3
Aug. 25, 2023 (CN) 202322300451.4

(51) Int. Cl. G02B 27/00; G02B 7/00; G03B 17/08

(52) U.S. Cl. CPC G02B 27/0006; G02B 7/008; G03B 17/08

(57) ABSTRACT

An optical device for preventing dew condensation including a housing, a transparent glass and a lens structure is provided. The housing has a first permeable portion capable of communicating between an interior and an exterior of the housing. The transparent glass has an inner surface and is coupled to the housing with the inner surface facing the interior of the housing. The lens structure is accommodated in the housing, and a chamber is formed between the lens structure, the housing and the inner surface of the transparent glass. The chamber and the exterior of the housing are capable of forming an airflow path therebetween, and the airflow path is adjustable to control whether an airflow is able to enter and exit the chamber and the exterior of the housing through the first permeable portion.

This application claims the benefit of People's Republic of China patent application Serial No. 202311081521.X, filed Aug. 25, 2023, the benefit of People's Republic of China patent application Serial No. 202322300372.3,filed Aug. 25, 2023, and the benefit of People's Republic of China patent application Serial No. 202322300451.4, filed Aug. 25, 2023, the invention of which are incorporated by reference herein in its entirety.

### TECHNICAL FIELD

The present invention relates in general to an optical device, and more particularly to an optical device for preventing dew condensation.

### BACKGROUND

With the advancement of technology, the application of an optical device becomes more and more diversified. The optical device may be, for example, a camera device, a surveillance device, an IP camera, an automotive camera, a projection device, etc. If the optical device is located in an environment where water vapor has reached a saturated state, it is easy to condense on surfaces at lower temperatures, resulting in condensation near the lens. If dew is generated on the path of light, not only will it affect the image quality, but it is also difficult to eliminate the dew generated inside the device.

### SUMMARY

The present invention is directed to an optical device for preventing dew condensation by adjusting the airflow path to equalize the water vapor with the outside world in order to achieve the effect of preventing dew condensation.

According to one aspect of the present invention, an optical device for preventing dew condensation is provided. The optical device includes a housing, a transparent glass and a lens structure. The housing has a first permeable portion capable of communicating between an interior and an exterior of the housing. The transparent glass has an inner surface and is coupled to the housing with the inner surface facing the interior of the housing. The lens structure is accommodated in the housing, and a chamber is formed between the lens structure, the housing and the inner surface of the transparent glass. An airflow path is formed between the chamber and the exterior of the housing, and the airflow path is adjustable to control whether an airflow is capable of entering and exiting the chamber and the exterior of the housing through the first permeable portion.

The optical device for preventing dew condensation according to the above, wherein the lens structure has a second permeable portion communicated to the chamber, and the airflow path is adjusted to be open in response to the first permeable portion corresponding to the second permeable portion and first permeable portion communicated to the interior and the exterior of the housing, so that the airflow passes through the first permeable portion and the second permeable portion to enter and exit the chamber and the exterior of the housing.

The optical device for preventing dew condensation according to the above, wherein the first permeable portion is aligned with the second permeable portion in response to the first permeable portion corresponding to the second permeable portion.

The optical device for preventing dew condensation according to the above, wherein the first permeable portion and the second permeable portion are openings of the housing and the lens structure, respectively.

The optical device for preventing dew condensation according to the above, further including a seal disposed between the housing and the lens structure to provide a hermetic connection; wherein the chamber is formed between the lens structure, the housing, the inner surface of the transparent glass and the seal.

The optical device for preventing dew condensation according to the above, wherein the seal and/or the lens structure extends the airflow path in response to the first permeable portion not corresponding to the second permeable portion.

The optical device for preventing dew condensation according to the above, wherein the lens structure includes a movable ring on which the second permeable portion is disposed.

The optical device for preventing dew condensation according to the above, wherein the movable ring is a focus ring or a zoom ring.

The optical device for preventing dew condensation according to the above, wherein the lens structure further includes a drive mechanism connected to the movable ring to drive the movable ring to rotate about and/or move along an optical axis of the lens structure.

The optical device for preventing dew condensation according to the above, further including a cover member movably disposed on the housing to selectively close or expose the first permeable portion; the airflow path is adjusted to be closed in response to the cover member closing the first permeable portion; the airflow path is adjusted to be open in response to the cover member exposing the first permeable portion.

The optical device for preventing dew condensation according to the above, further including a seal disposed between the housing and the lens structure to provide a hermetic connection; wherein the chamber is formed between the lens structure, the housing, the inner surface of the transparent glass and the seal.

The optical device for preventing dew condensation according to the above, further including a sensor disposed on the housing and facing the transparent glass; wherein the lens structure includes a movable ring and a drive mechanism connected to the movable ring to move the movable ring along an optical axis of the lens structure; the drive mechanism moves the movable ring along the optical axis in response to a condensation condition detected by the sensor so that a second permeable portion is formed between the movable ring and the seal, and the second permeable portion corresponds to the first permeable portion so that the airflow path is adjusted to be open to allow the airflow to enter and exit the chamber and the exterior of the housing through the second permeable portion and the first permeable portion.

The optical device for preventing dew condensation according to the above, wherein the second permeable portion is a gap formed between the movable ring and the seal.

The optical device for preventing dew condensation according to the above, wherein the movable ring abuts against the seal and hides the airflow path in response to the condensation condition not being detected by the sensor.

The optical device for preventing dew condensation according to the above, wherein the sensor is a temperature sensor for detecting a temperature of the inner surface of the transparent glass.

According to another aspect of the present invention, an optical device for preventing dew condensation is provided. The optical device includes a housing, a cover member, a transparent glass and a lens structure. The housing has an opening capable of communicating between an interior and an exterior of the housing. The cover member is movably disposed on the housing to selectively close or expose the opening. The transparent glass has an inner surface and is coupled to the housing with the inner surface facing the interior of the housing. The lens structure is accommodated in the housing, and a chamber is formed between the lens structure, the housing and the inner surface of the transparent glass. An airflow path into and out of the chamber and the exterior of the housing is formed through the opening in response to the cover member exposing the opening.

The optical device for preventing dew condensation according to the above, further including a seal disposed between the housing and the lens structure to provide a hermetic connection; wherein the chamber is formed between the lens structure, the housing, the inner surface of the transparent glass and the seal.

According to still another aspect of the present invention, an optical device for preventing dew condensation is provided. The optical device includes a housing, a transparent glass, a sensor, a lens structure and a seal. The housing has an opening capable of communicating between an interior and an exterior of the housing. The transparent glass has an inner surface and is coupled to the housing with the inner surface facing the interior of the housing. The sensor is disposed on the housing and faces the transparent glass. The lens structure is accommodated in the housing and includes a movable ring and a drive mechanism connected to the movable ring to move the movable ring along an optical axis of the lens structure. The seal is disposed between the housing and the lens structure to provide a hermetic connection, and a chamber formed between the lens structure, the housing, the inner surface of the transparent glass and the seal. The drive mechanism moves the movable ring along the optical axis in response to a condensation condition detected by the sensor so that the movable ring is spaced apart from the seal by a gap, the gap corresponds to the opening so that an airflow path into and out of the chamber and the exterior of the housing is formed through the gap and the opening.

The optical device for preventing dew condensation according to the above, wherein the movable ring abuts against the seal and hides the airflow path in response to the condensation condition not being detected by the sensor.

The optical device for preventing dew condensation according to the above, wherein the sensor is a temperature sensor for detecting a temperature of the inner surface of the transparent glass.

For a better understanding of the foregoing and other aspects of the present invention, the following embodiments, together with the accompanying drawings, are described in detail below.

### BRIEF DESCRIPTION OF THE DRAWINGS

FIG. 1 is a side view of an optical device according to one embodiment of the present invention, showing that the airflow path is adjusted to be closed.

FIG. 2 is a three-dimensional view of the optical device of FIG. 1.

FIG. 3 is a cross-sectional view of the optical device of FIG. 1 along the cut line 3-3′.

FIG. 4 is a side view of the optical device of FIG. 1, showing that the airflow path is adjusted to be open.

FIG. 5 is a three-dimensional view of the optical device of FIG. 4.

FIG. 6 is a cross-sectional view of the optical device of FIG. 4 along

the cut line 6-6′.

FIG. 7 is a side view of an optical device according to another embodiment of the present invention, showing that the airflow path is adjusted to be closed.

FIG. 8 is a three-dimensional view of the optical device of FIG. 7, showing that the airflow path is adjusted to be open.

FIG. 9 is a three-dimensional view of an optical device according to still another embodiment of the present invention, showing that the airflow path is adjusted to be closed.

FIG. 10 is a cross-sectional view of the optical device of FIG. 9 along the cut line 10-10′.

FIG. 11 is a three-dimensional view of the optical device of FIG. 9, showing that the airflow path is adjusted to be open.

FIG. 12 is a cross-sectional view of the optical device of FIG. 11 along the cut line 12-12′.

FIG. 13 is a cross-sectional view of an optical device according to a further embodiment of the present invention.

### DETAILED DESCRIPTION

The optical device of the present invention is provided with an adjustable airflow path to prevent dew condensation by balancing with external water vapor.

Various embodiments of the present invention will be described in detail below and illustrated with drawings. In addition to these detailed descriptions, the present invention may be broadly practiced in other embodiments, and easy substitutions, modifications, and equivalent variations of any of the described embodiments are encompassed within the scope of the present invention, subject to subsequent claims. In the description of the specification, many specific details and examples of embodiments are provided in order to provide the reader with a more complete understanding of the invention; however, these specific details and examples of embodiments should not be regarded as limitations of the invention. In addition, well-known steps or components are not described in detail to avoid unnecessary limitation of the invention.

The present invention provides an optical device for preventing dew condensation, which may be applied to any device equipped with an image-capturing lens, such as but not limited to, a photographic device, a surveillance device, an IP camera, an automotive camera, a projection device, etc.

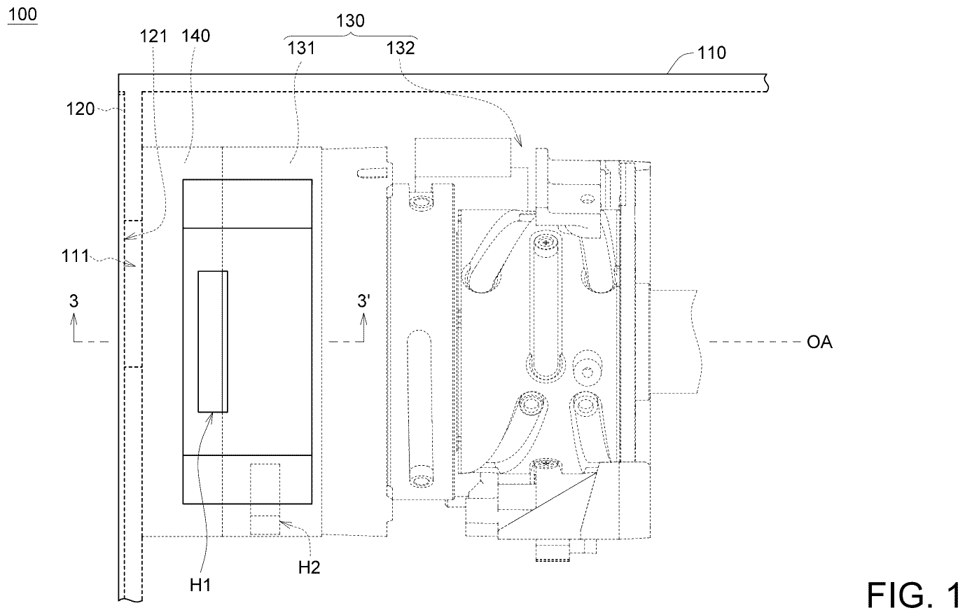

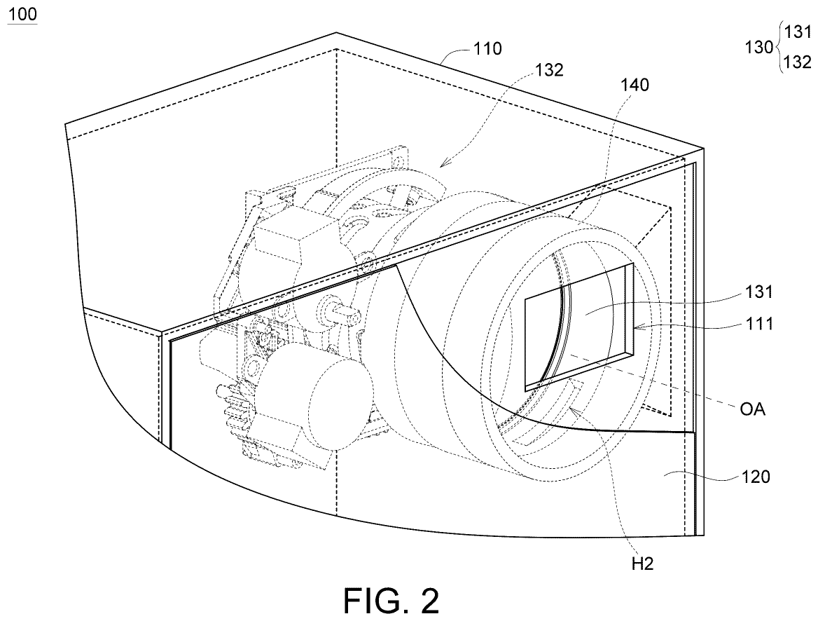

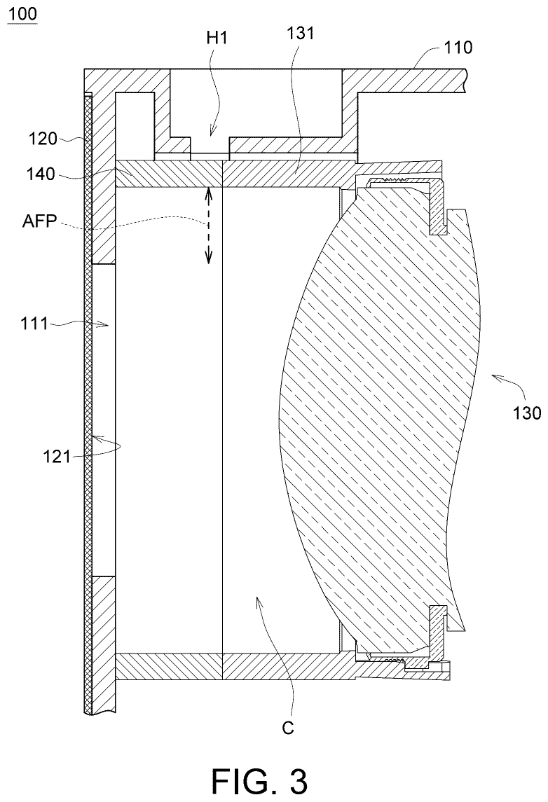

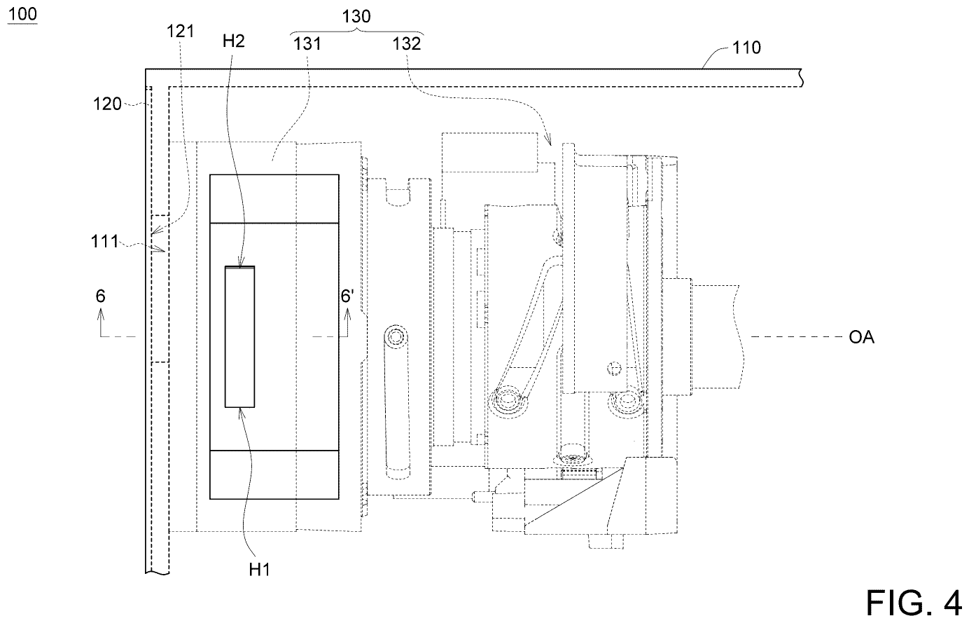

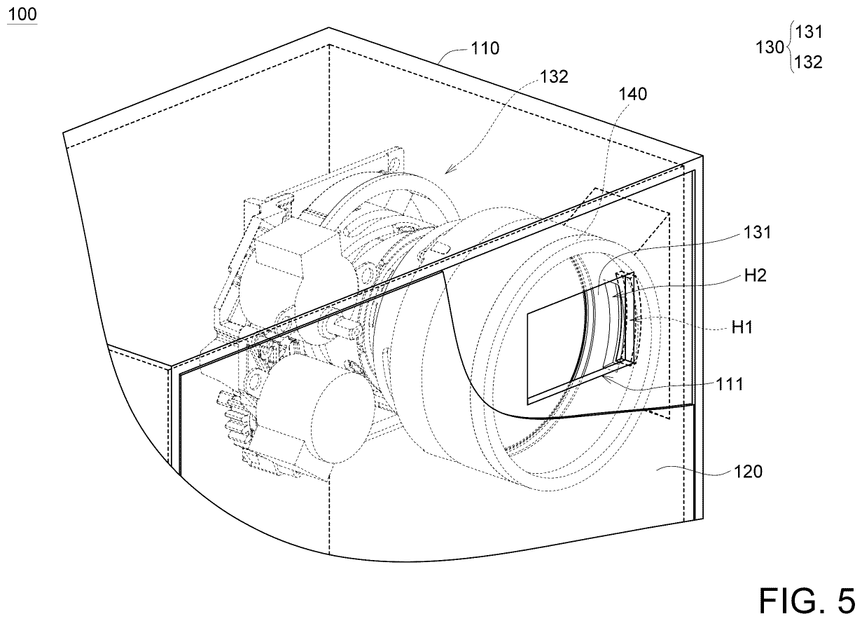

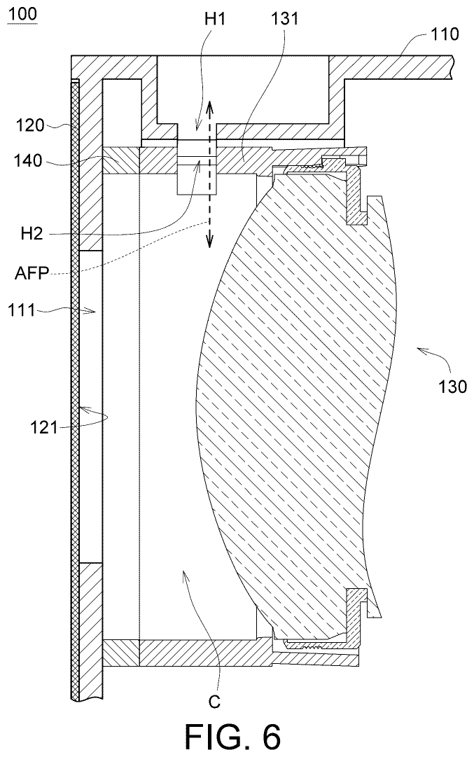

FIG. 1 is a side view of an optical device 100 according to one embodiment of the present invention, showing that the airflow path AFP is adjusted to be closed. FIG. 2 is a three-dimensional view of the optical device 100 of FIG. 1. FIG. 3 is a cross-sectional view of the optical device 100 of FIG. 1 along the cut line 3-3′. FIG. 4 is a side view of the optical device 100 of FIG. 1, showing that the airflow path AFP is adjusted to be open. FIG. 5 is a three-dimensional view of the optical device 100 of FIG. 4. FIG. 6 is a cross-sectional view of the optical device 100 of FIG. 4 along the cut line 6-6′.

Referring to FIG. 1 to FIG. 6, the optical device 100 may include at least a housing 110, a transparent glass 120 and a lens structure 130. The housing 110 has a light-transmitting opening 111. The lens structure 130 is accommodated in the housing 110, and the optical axis OA of the lens structure 130 may pass through the light-transmitting opening 111. In one embodiment, the optical axis OA of the lens structure 130 may be aligned with the light-transmitting opening 111, but this is not a limitation of the invention. In other embodiments, the optical axis OA of the lens structure 130 and the light-transmitting opening 111 may not be aligned with each other. The transparent glass 120 has an inner surface 121, and the transparent glass 120 is coupled to the housing 110 with the inner surface 121 facing the interior of the housing 110 and covering the light-transmitting opening 111.

A chamber C may be formed between the lens structure 130, the housing 110 and the inner surface 121 of the transparent glass 120. In one embodiment, the optical device 100 may further include a seal 140 disposed between the housing 110 and the lens structure 130 to provide a hermetic connection. Here, the chamber C may be formed between the lens structure 130, the housing 110, the inner surface 121 of the transparent glass 120 and the seal 140. The seal 140 may, but is not limited to, be rubber, silicone, or waterproof adhesive. In one embodiment, the seal 140 may be a continuous sealing ring structure that completely surrounds the connection between the lens structure 130 and the housing 110 to avoid creating a path between the seal 140 and the housing 110, or between the seal 140 and the lens structure 130, that may lead to a path into and out of the chamber C. In one embodiment, the seal 140 is pressed in an interference fit between the housing 110 and the lens structure 130. By the sealing member 140, the lens structure 130 may be connected to the housing 110 and abut against the housing 110 in a direction parallel to the optical axis OA. The seal 140 may be deformed in the direction parallel to the optical axis OA when the lens structure 130 moves in the direction parallel to the optical axis OA. In other embodiments, the optical device 100 may not include the seal 140. FIG. 1 to FIG. 6 illustrates the seal 140 by way of example only, and the seal 140 is not a limitation of the present invention. For example, if the lens structure 130 does not move in the direction parallel to the optical axis OA, the seal 140 may be omitted.

In addition, the upper right portion of the transparent glass 120 is eliminated in FIG. 2 and FIG. 5, thereby the light-transmitting opening 111 of the housing 110 is shown. It should be understood, however, that this portion is modified only to show some structural details more clearly, and that the actual transparent glass 120 exists as a whole surface. The use of the transparent glass 120 as an outward appearance may enhance the overall texture of the optical device 100. In addition, the transparent glass 120 basically does not affect the imaging effect of the lens structure 130; however, if the water vapor inside the housing 110 reaches a saturated state, and furthermore, if the water vapor inside the chamber C formed between the lens structure 130, the housing 110 and the inner surface 121 of the transparent glass 120 reaches a saturated state, dewdrops may be generated on the inner surface 121 of the transparent glass 120, which will affect the imaging quality. By forming an adjustable airflow path AFP between the chamber C and the exterior of the housing 110, the present invention balances the water vapor inside the chamber C with the water vapor outside the housing 110, thus achieving the effect of preventing dew condensation.

In detail, the housing 110 may have a first permeable portion H1, and the first permeable portion H1 may be capable of communicating between the interior and exterior of the housing 110. In one embodiment, the first permeable portion H1 may be an opening through the housing 110, through which air from the interior of the housing 110 may communicate to the exterior air. The lens structure 130 may have a second permeable portion H2, which is communicated to the chamber C. In one embodiment, the second permeable portion H2 may be an opening on the lens structure 130. In one specific embodiment, the lens structure 130 may include a movable ring 131 and a drive mechanism 132, the movable ring 131 being, for example, a focus ring or a zoom ring. The drive mechanism 132 is connected to the movable ring 131 to rotate the movable ring 131 about the optical axis OA of the lens structure 130, or to move the movable ring 131 along the optical axis OA, or to rotate the movable ring 131 about the optical axis OA and move it along the optical axis OA at the same time. The second permeable portion H2 may be disposed on the movable ring 131, and the second permeable portion H2 may be an opening through the movable ring 131, through which the air inside the chamber C may communicate to the air outside the movable ring 131.

As shown in the optical device 100 of FIG. 1 to FIG. 3, the first permeable portion H1 does not correspond to the second permeable portion H2, that is, the first permeable portion H1 and the second permeable portion H2 are misaligned with each other, and the air inside the chamber C does not directly communicate to the air outside the housing 110. Once the water vapor inside the chamber C reaches a saturated state and dewdrops are generated on the inner surface of the transparent glass 120, the user may control the drive mechanism 132 to move the movable ring 131 by pressing a button. As depicted in FIG. 4 to FIG. 6, the movable ring 131 may be rotated and displaced forward in the direction of the transparent glass 120 by the drive mechanism 132, so that the first permeable portion H1 corresponds to the second permeable portion H2. At this time, an open airflow path AFP is formed between the chamber C and the exterior of the housing 110. Here, the first permeable portion H1 may be fully correspond to the second permeable portion H2, such as shown in FIG. 4 to FIG. 6, where the first permeable portion H1 and the second permeable portion H2 have corresponding shapes or sizes, so that the first permeable portion H1 is aligned with the second permeable portion H2. In other embodiments not shown, the first permeable portion H1 and the second permeable portion H2 may be partially aligned, for example, the first permeable portion H1 and the second permeable portion H2 do not have corresponding shapes or sizes, or the first permeable portion H1 is not fully aligned with the second permeable portion H2. When the airflow path AFP is adjusted to be open, the airflow may enter and exit the chamber C and the exterior of the housing 110 through the first permeable portion H1 and the second permeable portion H2 to prevent water vapor inside the chamber C from condensing on the inner surface 121 of the transparent glass 120.

The airflow path AFP in FIG. 1 to FIG. 3 has a more extended path compared to the airflow path AFP in FIGS. 4 to 6. In the case of FIG. 1 to FIG. 3, since the seal 140 and/or the lens structure 130 (e.g., the movable ring 131) block the first permeable portion H1, the air inside the chamber C may only communicate to the interior of the housing 110 through the second permeable portion H2, which is misaligned with the first permeable portion H1, and in addition to this, the air arriving at the interior of the housing 110 needs to further flow to the first permeable portion H1 so as to communicate to the air outside the housing 110. Accordingly, the relatively long airflow path AFP formed in FIG. 1 to FIG. 3 substantially reduces the efficiency of airflow between the chamber C and the exterior of the housing 110. Once the water vapor accumulates in the chamber C, it does not effectively communicate to the air outside the housing 110. By rotating or moving the movable ring 131 so that the second permeable portion H2 corresponds to the first permeable portion H1, it is possible to form an airflow path AFP that may directly enter and exit the chamber C and the exterior of the housing 110, thus improving the efficiency of the airflow and thus avoiding the dew condensation phenomenon.

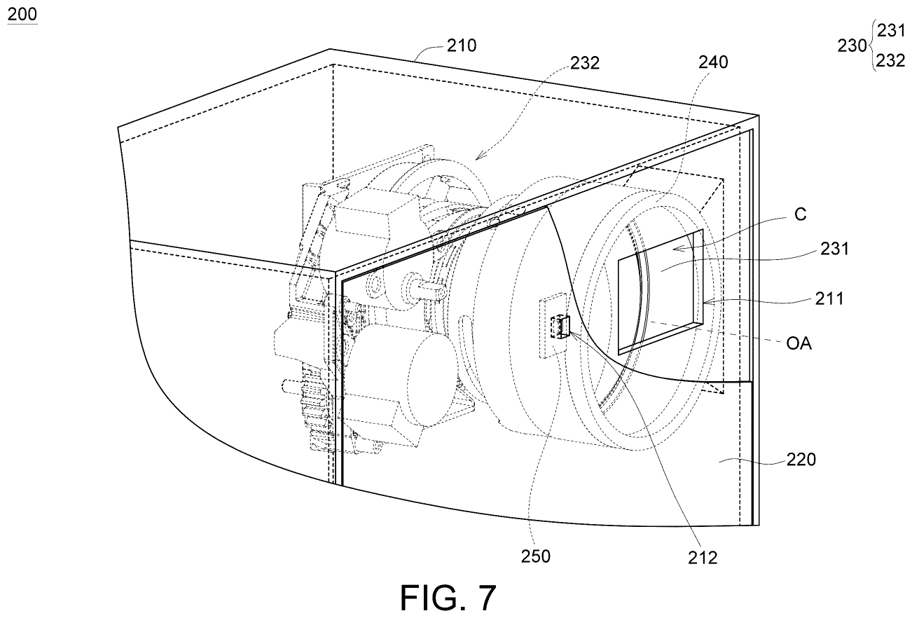

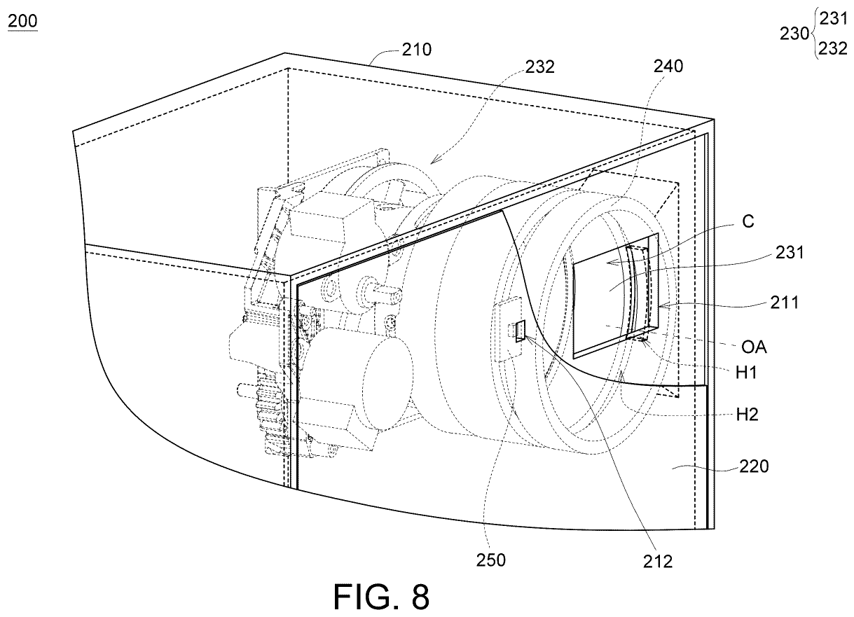

FIG. 7 is a side view of an optical device 200 according to another embodiment of the present invention, showing that the airflow path is adjusted to be closed. FIG. 8 is a three-dimensional view of the optical device 200 of FIG. 7, showing that the airflow path is adjusted to be open.

Referring to FIG. 7 and FIG. 8, the optical device 200 may include at least a housing 210, a transparent glass 220, a lens structure 230 and a sensor 250. The housing has a light-transmitting opening 211 and a perforation 212. The lens structure 230 is accommodated in the housing 210, and the optical axis OA of the lens structure 230 may pass through the light-transmitting opening 211. The optical axis OA may or may not be aligned with the light-transmitting opening 211. In one specific embodiment, the lens structure 230 may include a movable ring 231 and a drive mechanism 232. The movable ring 231 is, for example, a focus ring or a zoom ring. The drive mechanism 232 is connected to the movable ring 231 to move the movable ring 231 along the optical axis OA, or to rotate the movable ring 231 about the optical axis OA and move it along the optical axis OA at the same time. Similar to the optical device 100 of FIG. 1 to FIG. 6, the transparent glass 220 has an inner surface (not labeled), and the transparent glass 220 is coupled to the housing 210 with the inner surface facing the interior of the housing 210 and covering the light-transmitting opening 211 and the perforation 212. The sensor 250 is disposed on the housing 210 and faces the transparent glass 220. In one embodiment, the sensor 250 is, for example, a temperature sensor that may detect the temperature of the inner surface of the transparent glass 220 through the perforation 212.

A chamber C may be formed between the lens structure 230, the housing 220 and the inner surface of the transparent glass 220. In one embodiment, the optical device 200 may further include a seal 240 disposed between the housing 210 and the lens structure 230 to provide a hermetic connection. Here, the chamber C may be formed between the lens structure 230, the housing 220, the inner surface of the transparent glass 220 and the seal 240. The seal 240 is similar to the seal 140 depicted in FIG. 1 to FIG. 6, and will not be described herein. When the movable ring 231 of the lens structure 230 moves along the optical axis OA, the seal 240 may be deformed in a direction parallel to the optical axis OA.

In addition, the upper right portion of the transparent glass 220 is eliminated in FIG. 7 and FIG. 8, thereby the light-transmitting opening 211 of the housing 210 is shown. It should be understood, however, that this portion is modified only to show some structural details more clearly, and that the actual transparent glass 220 exists as a whole surface.

In the present embodiment, an adjustable airflow path (not labeled) may also be formed between the chamber C and the exterior of the housing 210, so that the water vapor inside the chamber C is balanced with the water vapor outside the housing 210, thus achieving the effect of preventing dew condensation. As shown in FIG. 7 and FIG. 8, the housing 210 may have a first permeable portion H1 (depicted in FIG. 8), and the first permeable portion H1 is capable of communicating with the interior and exterior of the housing 210. In one embodiment, the first permeable portion H1 may be an opening through the housing 210, and the air from the interior of the housing 210 may communicate to the air from the exterior through the opening. When the sensor 250 detects a condensation condition, e.g., a temperature below 5° C., the processor may send a signal to drive the drive mechanism 232 to move the movable ring 231 along the optical axis OA, causing the movable ring 231 to recede. Thus, a second permeable portion H2 is formed between the movable ring 231 and the seal 240, and the second permeable portion H2 corresponds to the first permeable portion H1, so as to adjust the airflow path to be open. In one specific embodiment, as shown in FIG. 8, the second permeable portion H2 may be a gap formed between the movable ring 231 and the seal 240. When the gap corresponds to the first permeable portion H1, the airflow path is adjusted to be open. At this time, the airflow may enter and exit the chamber C and the exterior of the housing 210 through the second permeable portion H2 and the first permeable portion H1, so as to prevent the water vapor inside the chamber C from condensing on the inner surface of the transparent glass 220. When the condensation condition is not established, the processor may command the drive mechanism 232 to drive the movable ring 231 forward to abut against the seal 240. Thus, the airflow path is blocked, so that the airflow path is adjusted to be closed.

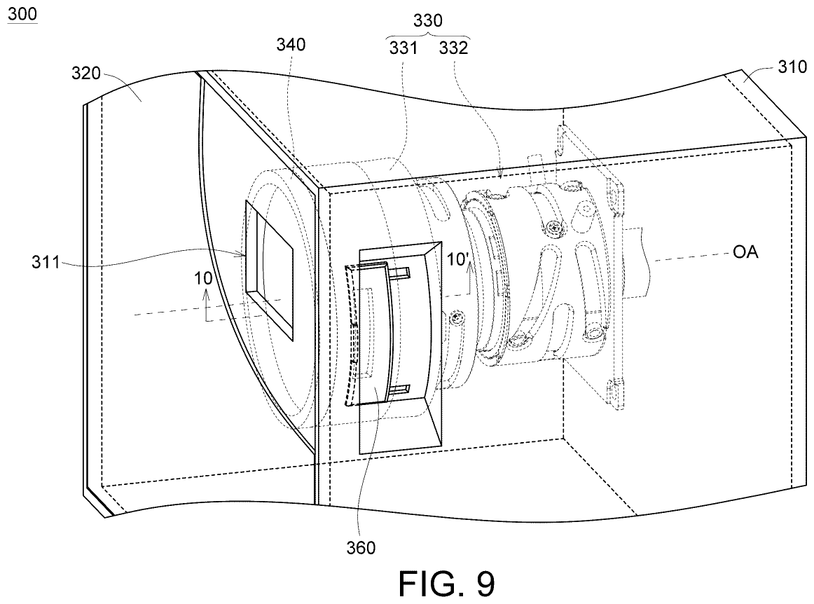

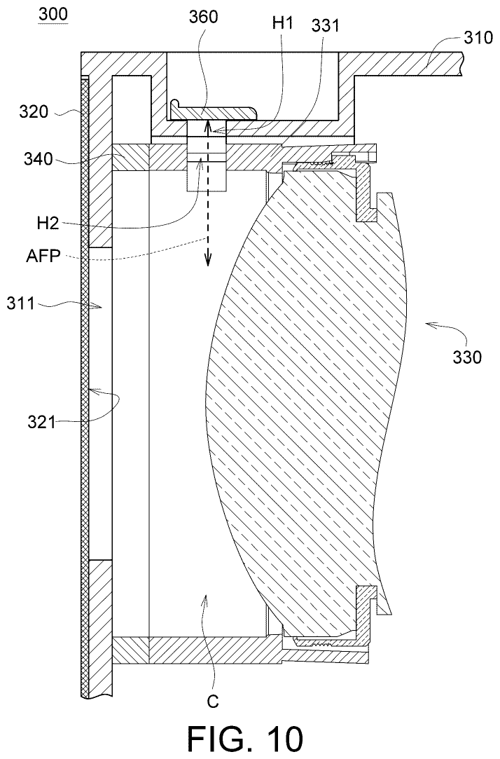

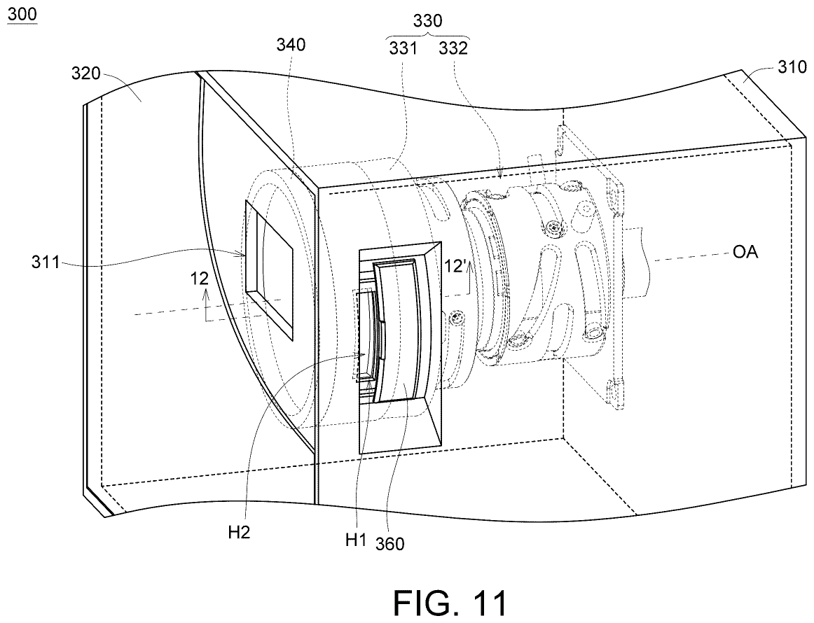

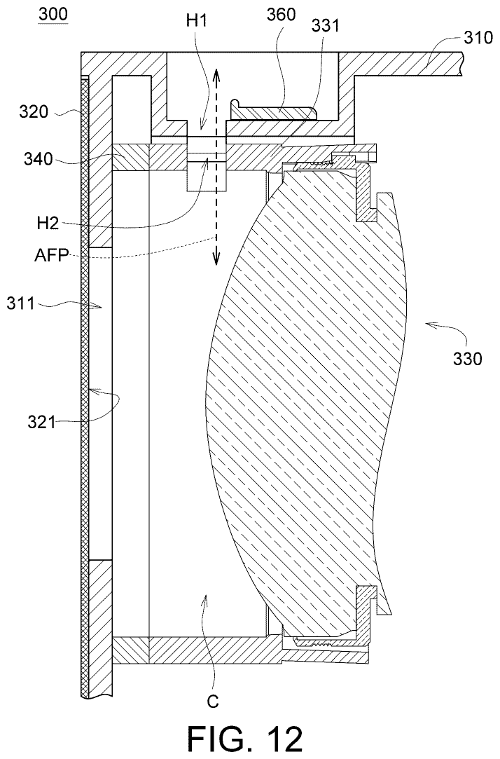

FIG. 9 is a three-dimensional view of an optical device 300 according to still another embodiment of the present invention, showing that the airflow path AFP is adjusted to be closed. FIG. 10 is a cross-sectional view of the optical device 300 of FIG. 9 along the cut line 10-10′. FIG. 11 is a three-dimensional view of the optical device 300 of FIG. 9, showing that the airflow path AFP is adjusted to be open. FIG. 12 is a cross-sectional view of the optical device 300 of FIG. 11 along the cut line 12-12′.

Referring to FIG. 9 to FIG. 12, the optical device 300 may include at least a housing 310, a transparent glass 320, a lens structure 330 and a cover member 360. The housing 310 has a light-transmitting opening 311. The lens structure 330 is accommodated in the housing 310, and the optical axis OA of the lens structure 330 may pass through the light-transmitting opening 311. The optical axis OA may or may not be aligned with the light-transmitting opening 311. Similar to the optical device 100 of FIG. 1 to FIG. 6, the transparent glass 320 has an inner surface 321, and the transparent glass 320 is coupled to the housing 310 with the inner surface facing the interior of the housing 310 and covering the light-transmitting opening 311.

A chamber C may be formed between the lens structure 330, the housing 320 and the inner surface 321 of the transparent glass 320. In one embodiment, the optical device 300 may further include a seal 340 disposed between the housing 310 and the lens structure 330 to provide a hermetic connection. Here, the chamber C may be formed between the lens structure 330, the housing 320, the inner surface 321 of the transparent glass 320 and the seal 340. The seal 340 is similar to the seal 140 depicted in FIG. 1 to FIG. 6, and will not be described herein. The seal 340 may be deformed in the direction parallel to the optical axis OA when the lens structure 330 moves in the direction parallel to the optical axis OA. In other embodiments, the optical device 300 may not include the seal 340. FIG. 9 to FIG. 12 illustrate the seal 340 by way of example only, and the seal 340 is not a limitation of the present invention. For example, if the lens structure 330 does not move in the direction parallel to the optical axis OA, the seal 340 may be omitted.

In addition, the upper right portion of the transparent glass 320 is eliminated in FIG. 9 and FIG. 11, thereby the light-transmitting opening 311 of the housing 310 is shown. It should be understood, however, that this portion is modified only to show some structural details more clearly, and that the actual transparent glass 320 exists as a whole surface.

In the present embodiment, an adjustable airflow path (not labeled) may also be formed between the chamber C and the exterior of the housing 310, so that the water vapor inside the chamber C is balanced with the water vapor outside the housing 310, thus achieving the effect of preventing dew condensation. As shown in FIG. 10, FIG. 11 and FIG. 12, the housing 310 may have a first permeable portion H1, and the first permeable portion H1 is capable of communicating with the interior and exterior of the housing 310. In one embodiment, the first permeable portion H1 may be an opening through the housing 310, and the air from the interior of the housing 310 may communicate to the air from the exterior through the opening. The lens structure 330 may have a second permeable portion H2 communicating to the chamber C. In one embodiment, the second permeable portion H2 may be an opening on the lens structure 330. In one specific embodiment, the lens structure 330 may include a movable ring 331 and a drive mechanism 332, the movable ring 331 being, for example, a focus ring or a zoom ring. The drive mechanism 332 is connected to the movable ring 331 to rotate the movable ring 331 about the optical axis OA of the lens structure 330, or to move the movable ring 331 along the optical axis OA, or to rotate the movable ring 331 about the optical axis OA and move it along the optical axis OA at the same time. The second permeable portion H2 may be disposed on the movable ring 331, and the second permeable portion H2 may be an opening through the movable ring 331.

In the states of FIG. 9 to FIG. 10 and FIG. 11 to FIG. 12, the second permeable portion H2 corresponds to the first permeable portion H1. Herein, the optical device 300 may close or open the airflow path AFP by the cover member 360. The cover member 360 may be movably disposed on the housing 310 to selectively close or expose the first permeable portion H1. When the cover member 360 closes the first permeable portion H1, the airflow path AFP is adjusted to be closed, as shown in FIG. 9 to FIG. 10. When the cover member 360 exposes the first permeable portion H1, the airflow path AFP is adjusted to be open. At this time, the airflow may enter and exit the chamber C and the exterior of the housing 310 through the second permeable portion H2 and the first permeable portion H1, so as to prevent the water vapor inside the chamber C from condensing on the inner surface 321 of the transparent glass 320. That is, when the user finds that there is a dew condensation on the inner surface 321 of the transparent glass 320, the user may open the cover member 360 to expose the first permeable portion H1, thus improving the dew condensation phenomenon.

In one embodiment, the cover member 360 may also be applied to the embodiment described in FIG. 1 to FIG. 6. If the movable ring 331 is similar to the movable ring 131 described in the embodiment of FIG. 1 to FIG. 6, e.g., the movable ring 331 may be rotated and displaced by the drive mechanism 332 in a forward direction toward the transparent glass 320 or in a backward direction far away from the transparent glass 320 so that the second permeable portion H2 and the first permeable portion H1 correspond to each other or do not correspond to each other, the user is still able to adjust the state of the airflow path AFP by opening or closing the cover member 360. For example, if the second permeable portion H2 and the first permeable portion H1 correspond to each other and the user observes that there is no dew condensation on the inner surface 321 of the transparent glass 320, the cover member 360 may be closed; or, if the cover member 360 is open but the second permeable portion H2 and the first permeable portion H1 do not correspond to each other, and the user observes that dew condensation slowly begins to form on the inner surface 321 of the transparent glass 320, the user may press a button to control the drive mechanism 332 to move the movable ring 331 so that the second permeable portion H2 and the first permeable portion H1 correspond to each other, thereby improving the efficiency of airflow between the chamber C and the exterior of the housing 310.

In one embodiment, the cover member 360 may also be applied to the embodiment described in FIG. 7 to FIG. 8. For example, if the second permeable portion H2 (e.g., a gap) corresponding to the first permeable portion H1 is formed between the movable ring 231 and the seal 240, and the user observes that there is no dew condensation on the inner surface of the transparent glass 220, the cover member 360 may be closed and the airflow path is directly adjusted to be closed.

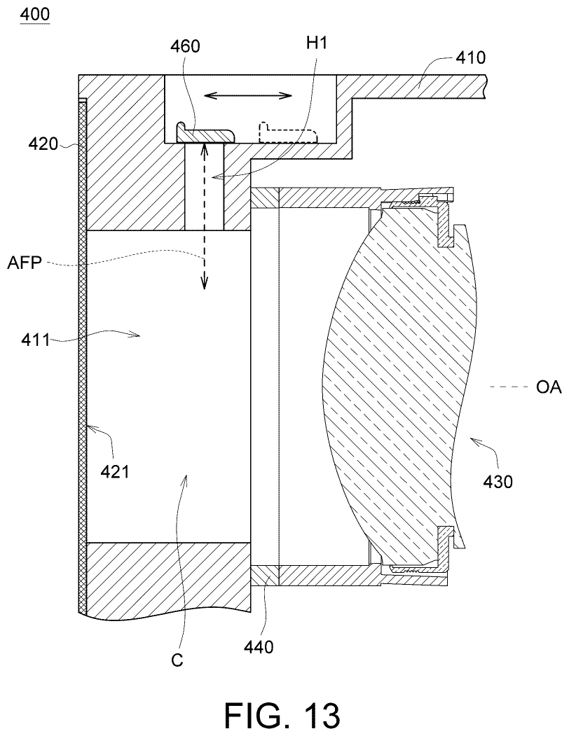

FIG. 13 is a cross-sectional view of an optical device 400 according to a further embodiment of the present invention. Referring to FIG. 13, the optical device 400 may include at least a housing 410, a transparent glass 420, a lens structure 430 and a cover member 460. The housing 410 has a light-transmitting opening 411. The lens structure 430 is accommodated in the housing 410, and the optical axis OA of the lens structure 430 may pass through the light-transmitting opening 411. The optical axis OA may be aligned with or not aligned with the light-transmitting opening 411. Similar to the optical device 100 of FIG. 1 to FIG. 6, the transparent glass 420 has an inner surface 421, and the transparent glass 420 is coupled to the housing 410 with the inner surface facing the interior of the housing 410 and covering the light-transmitting opening 411.

A chamber C may be formed between the lens structure 430, the housing 410 and the inner surface 421 of the transparent glass 420. In one embodiment, the optical device 400 may further include a seal 440 disposed between the housing 410 and the lens structure 430 to provide a hermetic connection. Here, the chamber C may be formed between the lens structure 430, the housing 410, the inner surface 421 of the transparent glass 420 and the seal 440. The seal 440 is similar to the seal 140 depicted in FIG. 1 to FIG. 6, and will not be described herein. The seal 440 may be deformed in the direction parallel to the optical axis OA when the lens structure 430 moves in the direction parallel to the optical axis OA. In other embodiments, the optical device 400 may not include the seal 440. FIG. 13 illustrates the seal 440 by way of example only, and the seal 440 is not a limitation of the present invention. For example, if the lens structure 430 does not move in the direction parallel to the optical axis OA, the seal 440 may be omitted.

In the present embodiment, an adjustable airflow path AFP may also be formed between the chamber C and the exterior of the housing 410, so that the water vapor inside the chamber C is balanced with the water vapor outside the housing 410, thus achieving the effect of preventing dew condensation. As shown in FIG. 13, the housing 410 may have a first permeable portion H1, and the first permeable portion H1 is capable of communicating with the interior and exterior of the housing 410. In one embodiment, the first permeable portion H1 may be an opening through the housing 410, and the air from the interior of the housing 410 may communicate to the air from the exterior through the opening.

Herein, the optical device 400 may close or open the airflow path AFP by the cover member 460. The cover member 460 may be movably disposed on the housing 410 to selectively close or expose the first permeable portion H1. When the cover member 460 closes the first permeable portion H1 (as shown by the cover member 460 drawn in solid lines in FIG. 13), the airflow path AFP is adjusted to be closed. When the cover member 460 exposes the first permeable portion H1 (as shown by the cover member 460 drawn in dotted lines in FIG. 13), the airflow path AFP is adjusted to be open. At this time, the airflow may enter and exit the chamber C and the exterior of the housing 410 through the first permeable portion H1, so as to prevent the water vapor inside the chamber C from condensing on the inner surface 421 of the transparent glass 420. That is, when the user finds that there is a dew condensation on the inner surface 421 of the transparent glass 420, the user may open the cover member 460 to expose the first permeable portion H1, thus improving the dew condensation phenomenon.

It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. An optical device for preventing dew condensation comprising:
a housing having a first permeable portion capable of communicating between an interior and an exterior of the housing;
a transparent glass having an inner surface, the transparent glass coupled to the housing with the inner surface facing the interior of the housing; and
a lens structure accommodated in the housing, a chamber formed between the lens structure, the housing and the inner surface of the transparent glass;
wherein an airflow path is formed between the chamber and the exterior of the housing, and the airflow path is adjustable to control whether an airflow is capable of entering and exiting the chamber and the exterior of the housing through the first permeable portion.

2. The optical device for preventing dew condensation according to claim 1, wherein the lens structure has a second permeable portion communicated to the chamber, and the airflow path is adjusted to be open in response to the first permeable portion corresponding to the second permeable portion and first permeable portion communicated to the interior and the exterior of the housing, so that the airflow passes through the first permeable portion and the second permeable portion to enter and exit the chamber and the exterior of the housing.

3. The optical device for preventing dew condensation according to claim 2, wherein the first permeable portion is aligned with the second permeable portion in response to the first permeable portion corresponding to the second permeable portion.

4. The optical device for preventing dew condensation according to claim 3, wherein the first permeable portion and the second permeable portion are openings of the housing and the lens structure, respectively.

5. The optical device for preventing dew condensation according to claim 2, further comprising a seal disposed between the housing and the lens structure to provide a hermetic connection; wherein the chamber is formed between the lens structure, the housing, the inner surface of the transparent glass and the seal.

6. The optical device for preventing dew condensation according to claim 5, wherein the seal and/or the lens structure extends the airflow path in response to the first permeable portion not corresponding to the second permeable portion.

7. The optical device for preventing dew condensation according to claim 2, wherein the lens structure comprises a movable ring on which the second permeable portion is disposed.

8. The optical device for preventing dew condensation according to claim 7, wherein the movable ring is a focus ring or a zoom ring.

9. The optical device for preventing dew condensation according to claim 7, wherein the lens structure further comprises a drive mechanism connected to the movable ring to drive the movable ring to rotate about and/or move along an optical axis of the lens structure.

10. The optical device for preventing dew condensation according to claim 1, further comprising a cover member movably disposed on the housing to selectively close or expose the first permeable portion; wherein the airflow path is adjusted to be closed in response to the cover member closing the first permeable portion; the airflow path is adjusted to be open in response to the cover member exposing the first permeable portion.

11. The optical device for preventing dew condensation according to claim 1, further comprising a seal disposed between the housing and the lens structure to provide a hermetic connection; wherein the chamber is formed between the lens structure, the housing, the inner surface of the transparent glass and the seal.

12. The optical device for preventing dew condensation according to claim 11, further comprising a sensor disposed on the housing and facing the transparent glass; wherein the lens structure comprises a movable ring and a drive mechanism connected to the movable ring to move the movable ring along an optical axis of the lens structure;
the drive mechanism moves the movable ring along the optical axis in response to a condensation condition detected by the sensor so that a second permeable portion is formed between the movable ring and the seal, and the second permeable portion corresponds to the first permeable portion so that the airflow path is adjusted to be open to allow the airflow to enter and exit the chamber and the exterior of the housing through the second permeable portion and the first permeable portion.

13. The optical device for preventing dew condensation according to claim 12, wherein the second permeable portion is a gap formed between the movable ring and the seal.

14. The optical device for preventing dew condensation according to claim 12, wherein the movable ring abuts against the seal and hides the airflow path in response to the condensation condition not being detected by the sensor.

15. The optical device for preventing dew condensation according to claim 12, wherein the sensor is a temperature sensor for detecting a temperature of the inner surface of the transparent glass.

16. An optical device for preventing dew condensation comprising:
a housing having an opening capable of communicating between an interior and an exterior of the housing;
a cover member movably disposed on the housing to selectively close or expose the opening;
a transparent glass having an inner surface, the transparent glass coupled to the housing with the inner surface facing the interior of the housing; and
a lens structure accommodated in the housing, a chamber formed between the lens structure, the housing and the inner surface of the transparent glass;
wherein an airflow path into and out of the chamber and the exterior of the housing is formed through the opening in response to the cover member exposing the opening.

17. The optical device for preventing dew condensation according to claim 16, further comprising a seal disposed between the housing and the lens structure to provide a hermetic connection; wherein the chamber is formed between the lens structure, the housing, the inner surface of the transparent glass and the seal.

18. An optical device for preventing dew condensation comprising:
a housing having an opening capable of communicating between an interior and an exterior of the housing;
a transparent glass having an inner surface, the transparent glass coupled to the housing with the inner surface facing the interior of the housing;
a sensor disposed on the housing and facing the transparent glass;
a lens structure accommodated in the housing, the lens structure comprising a movable ring and a drive mechanism connected to the movable ring to move the movable ring along an optical axis of the lens structure; and
a seal disposed between the housing and the lens structure to provide a hermetic connection, a chamber formed between the lens structure, the housing, the inner surface of the transparent glass and the seal;
wherein the drive mechanism moves the movable ring along the optical axis in response to a condensation condition detected by the sensor so that the movable ring is spaced apart from the seal by a gap, the gap corresponds to the opening so that an airflow path into and out of the chamber and the exterior of the housing is formed through the gap and the opening.

19. The optical device for preventing dew condensation according to claim 18, wherein the movable ring abuts against the seal and hides the airflow path in response to the condensation condition not being detected by the sensor.

20. The optical device for preventing dew condensation according to claim 18, wherein the sensor is a temperature sensor for detecting a temperature of the inner surface of the transparent glass.
